(19) United States
(12) Patent Application Publication
(10) Pub. No.: US 2016/0068657 A1
(43) Pub. Date: Mar. 10, 2016

(54) INHIBITION OF POLYMER SURFACE OXIDATION UTILIZING TWO PRIMARY ANTIOXIDANTS IN ACRYLIC POLYMERS

(71) Applicant: EASTMAN CHEMICAL COMPANY, Kingsport, TN (US)

(72) Inventor: Katherine Finlay, Kingsport, TN (US)

(73) Assignee: EASTMAN CHEMICAL COMPANY, Kingsport, TN (US)

(21) Appl. No.: 14/478,638

(22) Filed: Sep. 5, 2014

(51) Int. Cl. C08K 5/13; C08L 33/12

(52) U.S. Cl. CPC C08K 5/13; C08L 33/12

(57) ABSTRACT

This invention relates to a polymer composition comprising:
(A) an acrylic polymer, and
(B) a stabilizing composition comprising:
   (1) a phenolic antioxidant without a long-chain substituent; and
   (2) a phenolic antioxidant with a long-chain substituent,

wherein the phenolic antioxidant (1) has 10 to 20 carbon atoms,

wherein the phenolic antioxidant (2) has greater than 20 carbon atoms, and
wherein the weight ratio of phenolic antioxidant (1) to phenolic antioxidant (2) is from 0.7:1 to 1.3:1.

### FIELD OF THE INVENTION

This invention relates to a combination of two phenolic antioxidants used in combination to impede oxidative degradation at the surface of acrylic polymeric materials.

### BACKGROUND OF THE INVENTION

Polymeric materials are subject to oxidative polymer degradation during processing and usage due to exposures such as ultraviolet light. More specifically, surface oxidative degradation may occur in exposures to environments containing free radicals. Oxidative degradation is typically hindered by incorporating antioxidants into the material to prevent degradation of the bulk material.

There are two main types of antioxidants, referred to as primary and secondary, and defined by their mode of operation. Primary antioxidants are free radical scavengers that generally terminate free radical chain propagation by donating a hydrogen atom and include hindered phenols and secondary aromatic amines. Secondary antioxidants are hydroperoxide radical decomposers that operate by decomposing the radical into stable non-reactive products and are typically divalent sulfur or trivalent phosphorous.

Antioxidants have also been used to hinder oxidation at the surface of a polymeric material. It has been noted in the art that combining a radical scavenger antioxidant with a peroxide decomposer antioxidant can result in synergistic effects because of complementary but different reaction mechanisms.

### SUMMARY OF THE INVENTION

This invention is believed to show synergistic effects in impeding oxidative degradation at the surface of acrylic polymeric materials. In addition, this invention is believed to outperform combinations comprised of the more typical radical scavenger and peroxide decomposer antioxidants, as well as other combinations of different primary antioxidants with similar chemistries.

In one embodiment, this invention relates to a polymer composition comprising:
(A) an acrylic polymer, and
(B) a stabilizing composition comprising:
   (1) a phenolic antioxidant without a long-chain substituent; and
   (2) a phenolic antioxidant with a long-chain substituent,

wherein the phenolic antioxidant (1) has 10 to 20 carbon atoms,

wherein the phenolic antioxidant (2) has greater than 20 carbon atoms,

wherein the weight ratio of phenolic antioxidant (1) to phenolic antioxidant (2) is from 0.7:1 to 1.3:1.

In one embodiment, this invention relates to a polymer composition comprising:
(A) poly(methylmethacrylate) (PMMA), and
(B) a stabilizing composition comprising:
   (1) a phenolic antioxidant without a long-chain substituent; and
   (2) a phenolic antioxidant with a long-chain substituent,

wherein the phenolic antioxidant (1) has 10 to 20 carbon atoms,

wherein the phenolic antioxidant (2) has greater than 20 carbon atoms, and

wherein the weight ratio of phenolic antioxidant (1) to phenolic antioxidant (2) is from 0.7:1 to 1.3:1.

In one embodiment, this invention relates to a polymer composition comprising:
(A) at least one styrene-methyl methacrylate copolymer (NAS), and
(B) a stabilizing composition comprising:
   (1) a phenolic antioxidant without a long-chain substituent; and
   (2) a phenolic antioxidant with a long-chain substituent,

wherein the phenolic antioxidant (1) has 10 to 20 carbon atoms,

wherein the phenolic antioxidant (2) has greater than 20 carbon atoms, and

wherein the weight ratio of phenolic antioxidant (1) to phenolic antioxidant (2) is from 0.7:1 to 1.3:1.

For the purposes of this invention, “long chain substituent” means that the substituent itself has at least one of the following number of carbon atoms: 8 or more, or 10 or more, or 8 to 25, or 8 to 20, or 8 to 18, or 10 to 25, or 10 to 20, or 10 to 18.

In one embodiment of the invention, at least one phenolic antioxidant (1) is butylated hydroxytoluene (BHT) or butylated hydroxyanisole (BHA) or tert-butylhydroquinone (TBHQ). In one embodiment, phenolic antioxidant (1) is butylated hydroxytoluene (BHT). In one embodiment, tert-butylhydroquinone (TBHQ) is excluded from the scope of the invention. In one embodiment, phenolic antioxidants that contain more than one hydroxyl substituent are excluded from the scope of the invention. In one embodiment, phenolic antioxidant (1) can contain 10 to 20 carbon atoms. In one embodiment, phenolic antioxidant (1) can contain 11 to 20 carbon atoms. In any of the embodiments of the invention, phenolic antioxidant (1) can be sterically hindered.

In one embodiment, phenolic antioxidant (2) can have over 20 carbon atoms. In one embodiment, phenolic antioxidant (2) can have 20 to 70 carbon atoms or 20 to 65 carbon atoms or 20 to 60 carbon atoms or 20 to 55 carbon atoms or 20 to 50 carbon atoms or 20 to 45 carbon atoms or 20 to 40 carbon atoms or 20 to 35 carbon atoms or 20 to 30 carbon atoms. In any of the embodiments of the invention, phenolic antioxidant (2) can be sterically hindered.

In another embodiment, at least one phenolic antioxidant (2) is octadecyl-3-(3,5-di-tert-butyl-4-hydroxyphenyl)-propionate (A01076) (otherwise known as octadecyl-3,5-di-(tert)-butyl-4-hydroxyhydrocinnamate). In yet another embodiment, phenolic antioxidant (2) is α-tocopherol (Vitamin E).

In one embodiment, the combination of BHT and Vitamin E is used.

In one embodiment, the combination of BHT and A01076 is used.

In one embodiment, the combination of BHA and Vitamin E is used.

In one embodiment, the combination of BHA and A01076 is used.

In one embodiment, the polymer compositions of the invention comprising: (a) at least one acrylic polymer, (b) at least one mold release agent, and (c) the stabilizing composition useful in the invention.

In one embodiment, the acrylic polymers useful in the invention are selected from the group consisting of styrene-methyl methacrylate copolymers (NAS), styrene acrylonitrile (SAN), poly(ethylmethacrylate) (PEMA) and poly(methylmethacrylate) (PMMA).

In one embodiment, the stabilizing composition useful in the polymer compositions of the invention are selected from the group consisting of styrene-methyl methacrylate copolymers, and poly(methylmethacrylate).

In one embodiment, the stabilizing composition useful in the polymer compositions of the invention are selected from the group consisting of styrene-methyl methacrylate copolymer (70:30) (NAS 30), and poly(methyl methacrylate).

In one embodiment, the invention comprises a polymer composition comprising: (a) at least one acrylic polymer, for example, PMMA or NAS, (b) at least one mold release agent, wherein the mold release agent is not zinc stearate, and (c) the stabilizing composition useful in the invention.

In one embodiment, the mold release agent can be selected from erucylamide, stearamide, calcium stearate, stearic acid, montanic acid, montanic acid esters, montanic acid salts, oleic acid, palmitic acid, paraffin wax, polyethylene waxes, polypropylene waxes, carnauba wax, glycerol monostearate, or glycerol distearate or combinations thereof.

In one embodiment, at least one mold release agent can be selected from stearic acid and/or palmitic acid.

In one embodiment, the mold release agent is not zinc stearate.

The total amount of phenolic antioxidant(s) useful in the invention (total loading) can be present in the amount of: 0.01 to 5 weight percent or from 0.01 to 1.5 weight percent or 0.01 to 1.0 weight percent, 0.01 to 0.5 weight percent or 0.05 to 0.30 weight percent or 0.05 to 0.20 weight percent or 0.05 to 0.15 weight percent or 0.30 to 0.70 weight percent or 0.30 to 0.60 weight percent or 0.30 to 0.50 weight percent or 0.35 to 0.50 weight percent or 0.35 to 0.45 weight percent, based on the total weight percentage of the polymer composition, and as measured by HPLC analysis of the final polymer composition.

In one embodiment, the total amount of phenolic antioxidant(s) in the PMMA polymers useful in the invention (total loading) can be present in the amount of: 0.30 to 0.50 weight percent or 0.35 to 0.45 weight percent, based on the total weight percentage of the polymer composition, and as measured by HPLC analysis of the final polymer composition.

In one embodiment, the total amount of phenolic antioxidant(s) for the NAS polymers useful in the invention (total loading) can be present in the amount of: 0.01 to 0.5 weight percent or 0.05 to 0.30 weight percent or 0.05 to 0.20 weight percent or 0.05 to 0.15 weight percent, based on the total weight percentage of the polymer composition, and as measured by HPLC analysis of the final polymer composition.

In one embodiment, the acrylic polymer compositions containing the stabilizing compositions useful in the invention, can have a transmission percentage of at least 75% or at least 70% or at least 65% or at least 60% or at least 55% or at least 50% or at least 45% or at least 40% as determined by the method described in the Examples and under the conditions described in Table 2 and Table 3 herein.

In one embodiment, the acrylic polymer compositions containing the stabilizing compositions useful in the invention can have a transmission percentage of at least 75% or at least 70% or at least 65% or at least 60% or at least 55% or at least 50% or at least 45% or at least 40% as determined by the method described in the Examples and under the conditions described in Table 2 and Table 3 when using canola oil.

In one embodiment, the acrylic polymer compositions containing the stabilizing compositions useful in the invention can have a transmission percentage of at least 75% or at least 70% or at least 65% or at least 60% or at least 55% or at least 50% or at least 45% or at least 40% as determined by the method described in the Examples and under the conditions described in Table 2 and Table 3 herein when using canola oil and when using Solid Power XL detergent.

In one embodiment, the NAS polymer compositions containing the stabilizing compositions useful in the invention can have a transmission percentage of at least 75% or at least 70% or at least 65% or at least 60% as determined by the method described in the Examples and under the conditions described in Table 2 and Table 3 herein.

In one embodiment, the NAS polymer compositions containing the stabilizing compositions useful in the invention can have a transmission percentage of at least 75% or at least 70% or at least 65% or at least 60% as determined by the method described in the Examples and under the conditions described in Table 2 and Table 3 herein when using canola oil.

In one embodiment, the NAS polymer compositions containing the stabilizing compositions useful in the invention can have a transmission percentage of at least 75% or at least 70% or at least 65% or at least 60% as determined by the method described in the Examples and under the conditions described in Table 2 and Table 3 herein when using canola oil and when using Solid Power XL detergent.

In one embodiment, the PMMA polymer compositions containing the stabilizing compositions useful in the invention can have a transmission percentage of at least 50% or at least 45% or at least 40% as determined by the method described in the Examples and under the conditions described in Table 2 and Table 3 herein.

In one embodiment, the PMMA polymer compositions containing the stabilizing compositions useful in the invention can have a transmission percentage of at least 50% or at least 45% or at least 40% as determined by the method described in the Examples and under the conditions described in Table 2 and Table 3 herein when using canola oil.

In one embodiment, the PMMA polymer compositions containing the stabilizing compositions useful in of the invention can have a transmission percentage of at least 50% or at least 45% or at least 40% as determined by the method described in the Examples and under the conditions described in Table 2 and Table 3 herein when using canola oil and when using Solid Power XL detergent.

In one embodiment, the invention relates to a method for stabilizing any of the acrylic polymers useful in the invention against surface oxidative degradation, comprising:

incorporating into the acrylic polymer an effective stabilizing amount of the stabilizing composition of the invention.

### DETAIL DESCRIPTION OF THE INVENTION

The present invention may be understood more readily by reference to the following detailed description of certain embodiments of the invention and the working examples. In accordance with the purpose(s) of this invention, certain embodiments of the invention are described in the Summary of the Invention and are further described herein below. Also, other embodiments of the invention are described herein.

The combination of antioxidants useful in this invention outperformed combinations comprised of the more typical radical scavenger and peroxide decomposer antioxidants, as well as other combinations of different primary antioxidants with similar chemistries.

In one embodiment, this invention relates to a polymer composition comprising:
(A) an acrylic polymer, and
(B) a stabilizing composition comprising:
   (1) a phenolic antioxidant without a long-chain substituent; and
   (2) a phenolic antioxidant with a long-chain substituent,

wherein the phenolic antioxidant (1) has 10 to 20 carbon atoms,

wherein the phenolic antioxidant (2) has greater than 20 carbon atoms, and

wherein the weight ratio of phenolic antioxidant (1) to phenolic antioxidant (2) is from 0.7:1 to 1.3:1.

In one embodiment, this invention relates to a polymer composition comprising:
(A) PMMA and
(B) a stabilizing composition comprising:
   (1) a phenolic antioxidant without a long-chain substituent; and
   (2) a phenolic antioxidant with a long-chain substituent,

wherein the phenolic antioxidant (1) has 10 to 20 carbon atoms,

wherein the phenolic antioxidant (2) has greater than 20 carbon atoms, and

wherein the weight ratio of phenolic antioxidant (1) to phenolic antioxidant (2) is from 0.7:1 to 1.3:1.

In one embodiment, this invention relates to a polymer composition comprising:
(A) at least one NAS polymer, and
(B) a stabilizing composition comprising:
   (1) a phenolic antioxidant without a long-chain substituent; and
   (2) a phenolic antioxidant with a long-chain substituent,

wherein the phenolic antioxidant (1) has 10 to 20 carbon atoms,

wherein the phenolic antioxidant (2) has greater than 20 carbon atoms, and

wherein the weight ratio of phenolic antioxidant (1) to phenolic antioxidant (2) is from 0.7:1 to 1.3:1.

In one embodiment of the invention, the weight ratio of phenolic antioxidant (1) to phenolic antioxidant (2) can be any of 0.8:1 to 1.2:1 or from 0.9:1 to 1.1:1 or from 0.95:1 to 1.05:1.

In one embodiment of the invention, at least one phenolic antioxidant (1) can be butylated hydroxytoluene (BHT) or butylated hydroxyanisole (BHA) or tert-butylhydroquinone (TBHQ) or mixtures of at least two or more thereof. In one embodiment, at least one phenolic antioxidant (1) can be butylated hydroxytoluene (BHT) or butylated hydroxyanisole (BHA). In one embodiment, at least one phenolic antioxidant (1) can be butylated hydroxytoluene (BHT). In one embodiment, at least one phenolic antioxidant (1) can be butylated hydroxyanisole (BHA).

In one embodiment, at least one phenolic antioxidant (1) can be tert-butylhydroquinone (TBHQ). In one embodiment, TBHQ is excluded from the scope of this invention. In one embodiment, phenolic antioxidants that contain more than one hydroxyl group are excluded from the scope of the invention. In one embodiment, phenolic antioxidant (1) can have from 11 to 20 carbon atoms. In any of the embodiments of the invention, phenolic antioxidant (1) can be sterically hindered.

In one embodiment, phenolic antioxidant (2) can have over 20 carbon atoms. In one embodiment, phenolic antioxidant (2) can have 20 to 70 carbon atoms or 20 to 65 carbon atoms or 20 to 60 carbon atoms or 20 to 55 carbon atoms or 20 to 50 carbon atoms or 20 to 45 carbon atoms or 20 to 40 carbon atoms or 20 to 35 carbon atoms or 20 to 30 carbon atoms. In any of the embodiments of the invention, phenolic antioxidant (2) can be sterically hindered.

In one embodiment, at least one phenolic antioxidant (2) can be octadecyl-3-(3,5-di-tert-butyl-4-hydroxyphenyl)-propionate (A01076). In a further embodiment, at least one phenolic antioxidant (2) can be Vitamin E.

In one embodiment, the following combination of phenolic antioxidants can be useful in the invention: (1) butylated hydroxytoluene (BHT) and octadecyl-3-(3,5-di-tert-butyl-4-hydroxyphenyl)-propionate); (2) butylated hydroxyanisole (BHA) and octadecyl-3-(3,5-di-tert-butyl-4-hydroxyphenyl)-propionate)(AO 1076); (3) butylated hydroxyanisole (BHA) and Vitamin E; butylated hydroxytoluene (BHT) and Vitamin E.

In one embodiment, the stabilizing composition of the invention is butylated hydroxytoluene (BHT) and octadecyl-3-(3,5-di-tert-butyl-4-hydroxyphenyl)-propionate) (AO 1076).

The total amount of phenolic antioxidant(s) useful in the invention (total loading) can be present in the amount of: 0.01 to 5 weight percent or from 0.01 to 1.5 weight percent or 0.01 to 1.0 weight percent, 0.01 to 0.5 weight percent or 0.05 to 0.30 weight percent or 0.05 to 0.20 weight percent or 0.05 to 0.15 weight percent or 0.30 to 0.70 weight percent or 0.30 to 0.60 weight percent or 0.30 to 0.50 weight percent or 0.35 to 0.50 weight percent or 0.35 to 0.45 weight percent, based on the total weight percentage of the polymer composition and as measured by HPLC analysis of the final polymer composition.

In one embodiment, the total amount of phenolic antioxidant(s) in the PMMA polymers useful in the invention (total loading) can be present in the amount of: 0.30 to 0.50 weight percent or 0.35 to 0.45 weight percent, based on the total weight percentage of the polymer composition and as measured by HPLC analysis of the final polymer composition.

In one embodiment, the total amount of phenolic antioxidant(s) for the NAS polymers useful in the invention (total loading) can be present in the amount of: 0.01 to 0.5 weight percent or 0.05 to 0.30 weight percent or 0.05 to 0.20 weight percent or 0.05 to 0.15 weight percent, based on the total weight percentage of the polymer composition and as measured by HPLC analysis of the final polymer composition.

In one embodiment, the acrylic polymer composition can comprise a stabilizing composition comprising phenolic antioxidants (1) and (2) wherein the weight ratio of phenolic antioxidant (1) to phenolic antioxidant (2) is from 0.7:1 to 1.3:1 or from 0.8:1 to 1.2:1 or from 0.9:1 to 1.1:1 or from 0.95:1 to 1.05:1, and wherein the stabilizing composition is present at 0.01 to 5 weight percent or from 0.01 to 1.5 weight percent or 0.01 to 1.0 weight percent, 0.01 to 0.5 weight percent or 0.05 to 0.30 weight percent or 0.05 to 0.20 weight percent or 0.05 to 0.15 weight percent or 0.30 to 0.70 weight percent or 0.30 to 0.60 weight percent or 0.30 to 0.50 weight percent or 0.35 to 0.50 weight percent or 0.35 to 0.45 weight percent, based on the total weight percentage of the acrylic polymer composition and as measured by HPLC analysis of the final acrylic polymer composition.

In addition, it was noted that a loading level window including a minimum and maximum loading level, provided better performance than simply increasing the antioxidant levels.

Any of the above combinations of phenolic antioxidants may be used in conjunction with any of the weight percentages described herein for the stabilizing composition.

In one embodiment, the acrylic polymer useful in the invention is selected from the group consisting of PMMA polymer, NAS polymers, SAN polymers, and PEMA polymer.

In one embodiment, the invention comprises a polymer composition comprising: (a) at least one acrylic polymer, (b) at least one mold release agent and (c) the stabilizing composition useful in the invention.

In one embodiment, the invention comprises a polymer composition comprising: (a) at least one acrylic polymer, (b) at least one mold release agent wherein the mold release agent is not zinc stearate, and (c) the stabilizing composition useful in the invention.

In one embodiment, the mold release agent can be selected from erucylamide, stearamide, calcium stearate, stearic acid, montanic acid, montanic acid esters, montanic acid salts, oleic acid, palmitic acid, paraffin wax, polyethylene waxes, polypropylene waxes, carnauba wax, glycerol monostearate or glycerol distearate or combinations thereof.

In one embodiment, at least one mold release agent can be selected from stearic acid and palmitic acid or a combination thereof.

In one embodiment, the invention relates to a method for stabilizing any of the acrylic polymers useful in the invention against surface oxidative degradation, comprising:

incorporating into the acrylic polymer an effective stabilizing amount of a stabilizing composition.

In other aspects of the invention, the Tg of the acrylic polymers useful in the invention can be at least one of the following ranges: 80 to 130° C.; 80 to 125° C.; 80 to 120° C.; 80 to 115° C.; 80 to 110° C.; 80 to 105° C.; 80 to 100° C.; 80 to 95° C.; 85 to 130° C.; 85 to 125° C.; 85 to 120° C.; 85 to 115° C.; 85 to 110° C.; 85 to 105° C.; 85 to 100° C.; 85 to 95° C.; 90 to 130° C.; 90 to 125° C.; 90 to 120° C.; 90 to 115° C.; 90 to 110° C.; 90 to 105° C.; 90 to 100° C.; 95 to 130° C.; 95 to 125° C.; 95 to 120° C.; 95 to 115° C.; 95 to 110° C.; 95 to 105° C.; 100 to 130° C.; 100 to 125° C.; 100 to 120° C.; 100 to 115° C.; 100 to 110° C.; 105 to 130° C.; 105 to 125° C.; 105 to 120° C.; 105 to 115° C.; 110 to 130° C.; 110 to 125° C.; 110 to 120° C.; 115 to 130° C.; 115 to 125° C.; 115 to 120° C.; 115 to 130° C.; 115 to 125° C.; 115 to 120° C.; and 120 to 130° C.

For certain embodiments of the invention, the acrylic polymers useful in the invention may exhibit at least one of the following inherent viscosities as determined in 60/40 (wt/wt) phenol/tetrachloroethane at a concentration of 0.5 g/100 ml at 25° C.: 0.35 to 1.2 dL/g; 0.35 to 1.1 dL/g; 0.35 to 1 dL/g; 0.35 to less than 1 dL/g; 0.35 to 0.98 dL/g; 0.35 to 0.95 dL/g; 0.35 to 0.90 dL/g; 0.35 to 0.85 dL/g; 0.35 to 0.80 dL/g; 0.35 to 0.75 dL/g; 0.35 to less than 0.75 dL/g; 0.35 to 0.72 dL/g; 0.35 to 0.70 dL/g; 0.35 to less than 0.70 dL/g; 0.35 to 0.68 dL/g; 0.35 to less than 0.68 dL/g; 0.35 to 0.65 dL/g; 0.40 to 1.2 dL/g; 0.40 to 1.1 dL/g; 0.40 to 1 dL/g; 0.40 to less than 1 dL/g; 0.40 to 0.98 dL/g; 0.40 to 0.95 dL/g; 0.40 to 0.90 dL/g; 0.40 to 0.85 dL/g; 0.40 to 0.80 dL/g; 0.40 to 0.75 dL/g; 0.40 to less than 0.75 dL/g; 0.40 to 0.72 dL/g; 0.40 to 0.70 dL/g; 0.40 to less than 0.70 dL/g; 0.40 to 0.68 dL/g; 0.40 to less than 0.68 dL/g.

For certain embodiments of the invention, the acrylic polymers useful in the invention may exhibit at least one of the following inherent viscosities as determined in 60/40 (wt/wt) phenol/tetrachloroethane at a concentration of 0.5 g/100 ml at 25° C.: 0.45 to 1.2 dL/g; 0.45 to 1.1 dL/g; 0.45 to 1 dL/g; 0.45 to 0.98 dL/g; 0.45 to 0.95 dL/g; 0.45 to 0.90 dL/g; 0.45 to 0.85 dL/g; 0.45 to 0.80 dL/g; 0.45 to 0.75 dL/g; 0.45 to less than 0.75 dL/g; 0.45 to 0.72 dL/g; 0.45 to 0.70 dL/g; 0.45 to less than 0.70 dL/g; 0.45 to 0.68 dL/g; 0.45 to less than 0.68 dL/g; 0.45 to 0.65 dL/g; 0.50 to 1.2 dL/g; 0.50 to 1.1 dL/g; 0.50 to 1 dL/g; 0.50 to less than 1 dL/g; 0.50 to 0.98 dL/g; 0.50 to 0.95 dL/g; 0.50 to 0.90 dL/g; 0.50 to 0.85 dL/g; 0.50 to 0.80 dL/g; 0.50 to 0.75 dL/g; 0.50 to less than 0.75 dL/g; 0.50 to 0.72 dL/g; 0.50 to 0.70 dL/g; 0.50 to less than 0.70 dL/g; 0.50 to 0.68 dL/g; 0.50 to less than 0.68 dL/g; 0.50 to 0.65 dL/g; 0.55 to 1.2 dL/g; 0.55 to 1.1 dL/g; 0.55 to 1 dL/g; 0.55 to less than 1 dL/g; 0.55 to 0.98 dL/g; 0.55 to 0.95 dL/g; 0.55 to 0.90 dL/g; 0.55 to 0.85 dL/g; 0.55 to 0.80 dL/g; 0.55 to 0.75 dL/g; 0.55 to less than 0.75 dL/g; 0.55 to 0.72 dL/g; 0.55 to 0.70 dL/g; 0.55 to less than 0.70 dL/g; 0.55 to 0.68 dL/g; 0.55 to less than 0.68 dL/g; 0.55 to 0.65 dL/g; 0.58 to 1.2 dL/g; 0.58 to 1.1 dL/g; 0.58 to 1 dL/g; 0.58 to less than 1 dL/g; 0.58 to 0.98 dL/g; 0.58 to 0.95 dL/g; 0.58 to 0.90 dL/g; 0.58 to 0.85 dL/g; 0.58 to 0.80 dL/g; 0.58 to 0.75 dL/g; 0.58 to less than 0.75 dL/g; 0.58 to 0.72 dL/g; 0.58 to 0.70 dL/g; 0.58 to less than 0.70 dL/g; 0.58 to 0.68 dL/g; 0.58 to less than 0.68 dL/g; 0.58 to 0.65 dL/g; 0.60 to 1.2 dL/g; 0.60 to 1.1 dL/g; 0.60 to 1 dL/g; 0.60 to less than 1 dL/g; 0.60 to 0.98 dL/g; 0.60 to 0.95 dL/g; 0.60 to 0.90 dL/g; 0.60 to 0.85 dL/g; 0.60 to 0.80 dL/g; 0.60 to 0.75 dL/g; 0.60 to less than 0.75 dL/g; 0.60 to 0.72 dL/g; 0.60 to 0.70 dL/g; 0.60 to less than 0.70 dL/g; 0.60 to 0.68 dL/g; 0.60 to less than 0.68 dL/g; 0.60 to 0.65 dL/g; 0.65 to 1.2 dL/g; 0.65 to 1.1 dL/g; 0.65 to 1 dL/g; 0.65 to less than 1 dL/g; 0.65 to 0.98 dL/g; 0.65 to 0.95 dL/g; 0.65 to 0.90 dL/g; 0.65 to 0.85 dL/g; 0.65 to 0.80 dL/g; 0.65 to 0.75 dL/g; and 0.65 to less than 0.75 dL/g.

The acrylic polymer(s) useful in the invention are comprised of monomers or mixtures of monomers including, but not limited to: methyl acrylate, butyl acrylate, methyl methacrylate, ethyl acrylate, ethyl methacrylate, butyl acrylate, butyl methacrylate, cyclohexylacrylate, cyclohexylmethacrylate, styrene, methylstyrene, and other monomers known to function in a similar manner to any of the monomers listed above. These acrylic polymers may be prepared by methods which are well known in the art. See Encyclopedia of Polymer Science and Technology, John Wiley & Sons (1985).

In one embodiment of the invention, polyacrylates such as polymethyl methacrylate (PMMA), polyethyl methacrylate (PEMA), or copolymers thereof are useful in the invention such as those which are commercially available from Rohm and Haas. Copolymers such as styrene-methylmethacrylate copolymer (NAS) are useful in one embodiment of the invention. Styrene:methylmethacrylate copolymer (70:30) (NAS 30) is useful in another embodiment of the invention. In addition, styrene acrylonitrile (SAN) can also be useful in the invention. These are common commercial polymers which are available from companies such as Air Products and Chemicals, Inc. In one embodiment, the polyacrylate useful in the invention is PMMA.

Both types of phenolic antioxidants are commercially available and can be added to a polymer via compounding after polymerization and prior to molding.

In one embodiment, the conditions for the term “effective stabilizing amount” are met either if the stabilizing composition of the invention is present in an amount sufficient to provide the specified transmission rates described herein for the polymers specified or if the loading levels of the stabilizing composition of the invention as are specified for the types of polymers useful in the invention.

In one embodiment, the polymer compositions containing the stabilizing compositions of the invention, for example, the acrylic polymer compositions, can have a transmission percentage of at least 75% or at least 70% or at least 65% or at least 60% or at least 55% or at least 50% or at least 45% or at least 40% as determined by the method described in the Examples and under the conditions described in Table 2 and Table 3 herein.

In one embodiment, the polymer compositions containing the stabilizing compositions of the invention, for example, the acrylic polymer compositions, can have a transmission percentage of at least 75% or at least 70% or at least 65% or at least 60% or at least 55% or at least 50% or at least 45% or at least 40% as determined by the method described in the Examples and under the conditions described in Table 2 and Table 3 when using canola oil.

In one embodiment, the polymer compositions containing the stabilizing compositions of the invention, for example, the acrylic polymer compositions, can have a transmission percentage of at least 75% or at least 70% or at least 65% or at least 60% or at least 55% or at least 50% or at least 45% or at least 40% as determined by the method described in the Examples and under the conditions described in Table 2 and Table 3 herein when using canola oil and when using Solid Power XL detergent.

In one embodiment, the polymer compositions containing the stabilizing compositions of the invention, for example, the NAS polymer compositions useful in the invention, can have a transmission percentage of at least 75% or at least 70% or at least 65% or at least 60% as determined by the method described in the Examples and under the conditions described in Table 2 and Table 3 herein.

In one embodiment, the polymer compositions containing the stabilizing compositions of the invention, for example, the NAS polymer compositions, can have a transmission percentage of at least 75% or at least 70% or at least 65% or at least 60% a as determined by the method described in the Examples and under the conditions described in Table 2 and Table 3 herein when using canola oil.

In one embodiment, the polymer compositions containing the stabilizing compositions of the invention, for example, the NAS polymer compositions, can have a transmission percentage of at least 75% or at least 70% or at least 65% or at least 60% as determined by the method described in the Examples and under the conditions described in Table 2 and Table 3 herein when using canola oil and when using Solid Power XL detergent.

In one embodiment, the polymer compositions containing the stabilizing compositions of the invention, for example, the PMMA polymer compositions, can have a transmission percentage of at least 50% or at least 45% or at least 40% as determined by the method described in the Examples and under the conditions described in Table 2 and Table 3 herein.

In one embodiment, the polymer compositions containing the stabilizing compositions of the invention, for example, the PMMA polymer compositions, can have a transmission percentage of at least 50% or at least 45% or at least 40% as determined by the method described in the Examples and under the conditions described in Table 2 and Table 3 herein when using canola oil.

In one embodiment, the polymer compositions containing the stabilizing compositions of the invention, for example, the PMMA polymer compositions, can have a transmission percentage of at least 50% or at least 45% or at least 40% as determined by the method described in the Examples and under the conditions described in Table 2 and Table 3 herein when using canola oil and when using Solid Power XL detergent.

In one embodiment, the acrylic polymers useful in the invention and/or the acrylic polymer compositions of the invention, with or without toners, can have color values L*, a* and b* which can be determined using a Hunter Lab Ultrascan Spectra Colorimeter manufactured by Hunter Associates Lab Inc., Reston, Va. The color determinations are averages of values measured on either pellets of the acrylic polymers or plaques or other items injection molded or extruded from them. They are determined by the L*a*b* color system of the CIE (International Commission on Illumination) (translated), wherein L* represents the lightness coordinate, a* represents the red/green coordinate, and b* represents the yellow/blue coordinate. In certain embodiments, the b* values for the acrylic polymers useful in the invention can be from −10 to less than 10 and the L* values can be from 50 to 90. In other embodiments, the b* values for the acrylic polymers useful in the invention can be present in one of the following ranges: −10 to 9; −10 to 8; −10 to 7; −10 to 6; −10 to 5; −10 to 4; −10 to 3; −10 to 2; from −5 to 9; −5 to 8; −5 to 7; −5 to 6; −5 to 5; −5 to 4; −5 to 3; −5 to 2; 0 to 9; 0 to 8; 0 to 7; 0 to 6; 0 to 5; 0 to 4; 0 to 3; 0 to 2; 1 to 10; 1 to 9; 1 to 8; 1 to 7; 1 to 6; 1 to 5; 1 to 4; 1 to 3; and 1 to 2. In other embodiments, the L* value for the acrylic polymers useful in the invention can be present in one of the following ranges: 50 to 60; 50 to 70; 50 to 80; 50 to 90; 60 to 70; 60 to 80; 60 to 90; 70 to 80; 79 to 90.

In addition, the acrylic polymer compositions useful in this invention may also contain from 0.01 to 25% by weight or 0.01 to 20% by weight or 0.01 to 15% by weight or 0.01 to 10% by weight or 0.01 to 5% by weight of the total weight of the acrylic polymer composition of common additives such as colorants, dyes, mold release agents, flame retardants, plasticizers, nucleating agents, stabilizers, including but not limited to, UV stabilizers, thermal stabilizers and/or reaction products thereof, fillers, and impact modifiers. Examples of typical commercially available impact modifiers well known in the art and useful in this invention include, but are not limited to, ethylene/propylene terpolymers; functionalized polyolefins, such as those containing methyl acrylate and/or glycidyl methacrylate; styrene-based block copolymeric impact modifiers; and various acrylic core/shell type impact modifiers. For example, UV additives can be incorporated into articles of manufacture through addition to the bulk, through application of a hard coat, or through coextrusion of a cap layer. Residues of such additives are also contemplated as part of the acrylic polymer composition.

The acrylic polymers of the invention can comprise at least one chain extender. Suitable chain extenders include, but are not limited to, multifunctional (including, but not limited to, bifunctional) isocyanates, multifunctional epoxides, including for example, epoxylated novolacs, and phenoxy resins. In certain embodiments, chain extenders may be added at the end of the polymerization process or after the polymerization process. If added after the polymerization process, chain extenders can be incorporated by compounding or by addition during conversion processes such as injection molding or extrusion. The amount of chain extender used can vary depending on the specific monomer composition used and the physical properties desired but is generally about 0.1 percent by weight to about 10 percent by weight, preferably about 0.1 to about 5 percent by weight, based on the total weight of the acrylic polymer.

Reinforcing materials may be useful in the acrylic polymer compositions of this invention. The reinforcing materials may include, but are not limited to, carbon filaments, silicates, mica, clay, talc, titanium dioxide, Wollastonite, glass flakes, glass beads and fibers, and polymeric fibers and combinations thereof. In one embodiment, the reinforcing materials are glass, such as, fibrous glass filaments, mixtures of glass and talc, glass and mica, and glass and polymeric fibers.

The polymer compositions of this invention can be blended with any other polymer known in the art. For example, the acrylic polymer composition of the invention can comprise at least one polymer chosen from at least one of the following: poly(etherimides), polyphenylene oxides, poly(phenylene oxide)/polystyrene blends, polystyrene resins, polyphenylene sulfides, polyphenylene sulfide/sulfones, poly(ester-carbonates), polycarbonates, polysulfones; polysulfone ethers, and poly(ether-ketones).

In another embodiment, the invention further relates to articles of manufacture comprising any of the acrylic polymers and blends described above.

The acrylic polymer compositions and/or acrylic polymer blend compositions can be useful in forming fibers, films, molded articles, containers, and sheeting. The methods of forming the acrylic polymers into fibers, films, molded articles, containers, and sheeting are well known in the art.

As used herein, the abbreviation “wt” means “weight”. The inherent viscosity of the acrylic polymers was determined in 60/40 (wt/wt) phenol/tetrachloroethane at a concentration of 0.5 g/100 ml at 25° C. The following examples further illustrate how the compositions of matter of the invention can be made and evaluated, and are intended to be purely exemplary of the invention and are not intended to limit the scope thereof. Unless indicated otherwise, parts are parts by weight, temperature is in degrees C. or is at room temperature, loading level is measured in units of weight percentage as measured by HPLC analysis based on the total weight of the polymer composition; and pressure is at or near atmospheric.

### EXAMPLES

The following abbreviations apply throughout the working examples and specification:

TABLE 1

| | |
|---|---|
| AO 1076 | Octadecyl-3-(3,5-di-tert-butyl-4- |
| | hydroxyphenyl)-propionate [a phenolic |
| | antioxidant (2)] |
| BHA | Butylated hydroxyanisole [a phenolic |
| | antioxidant (1)] |
| BHT | Butylated hydroxytoluene [a phenolic |
| | antioxidant (1)] |
| HPLC | High Performance Liquid Chromatography |
| NAS (NAS 30) | Styrene:Methylmethacrylate Copolymer (70:30) |
| NIST | National Institute of Standards and Technology |
| NMR | Nuclear Magnetic Resonance Spectroscopy |
| OSD | Oxidative Surface Degradation |
| PMMA | Polymethyl Methacrylate Polymer |
| SAN | Styrene-Acrylonitrite Polymer |
| TBHQ | Tert-butylhydroquinone [a phenolic |
| | antioxidant (1)] |
| Vitamin E | α-tocopherol [a phenolic antioxidant (2)] |

### Preparation for Examples

The window of usefulness was defined by using a similar technique to one popular in the fiber reinforced composites arena to quantify the level of surface degradation in a polymeric material. Samples were first exposed to an oil for 24 h at 95° C. and then exposed to a detergent solution for up to 24 h at 95° C. After this exposure these samples may show a whitened appearance characteristic of oxidative surface degradation. To quantify this, a sample was placed on a high resolution (at least 1200 dpi) flatbed scanner in a room with no ambient or other artificial lighting, and imaged. This results in a captured image with a black background contrasting any whitened regions on the polymer. The image was then opened in ImageJ software, provided by NIST at no cost to all users, and converted into a binary image. The binary image was then analyzed to count the number of black vs. white pixels resulting in a percent area that showed surface degradation. In defining the window of usefulness for the antioxidant additives a percent transmission was used, defined hence forth as 100 minus the percent area showing surface degradation. The loading levels that showed the highest transmission in multiple applications were chosen as the appropriate loading window.

The level of antioxidant in a polymeric material was measured using HPLC with ultraviolet and charged aerosol detection. The samples underwent a liquid-liquid extraction, separating the antioxidants from the plastic material. For all antioxidants containing hindered phenolic compounds, levels were detected by exposing the chromaphoric nature of the phenyl functionality. For other antioxidants, detection was performed by exploiting the size of the compounds using charged aerosol detection. An external control was performed for all antioxidants examined and both detection methods employed. Control samples were prepared from standard materials at matrix comparable levels to ensure method reproducibility, while samples were also spiked with known concentrations of antioxidant standards. The recovered antioxidant level from the control samples was then compared with the spike loading level to validate the method calibration.

To test the efficacy of the antioxidant additives the following oxidative surface degradation testing (OSD testing) was performed. Each material was molded into 10.16×10.16×0.318 cm plaques that were then cut into 2.54×2.54×0.318 cm squares and a 0.635 cm diameter hole was drilled in the center. Four squares were then placed in canola oil for 24 hours at 95° C. and upon removal were hand washed with Dawn Ultra dish washing liquid commercially available from Proctor and Gamble, Cincinnati, Ohio. Four squares were then placed on a screw with washers in between each square, and the squares were then immersed in 40 mL of Solid Power XL detergent solution for up to 24 hrs at 95° C.

The canola oil used in these examples is commonly known in the art and is commercially available under the following brand name: Best Choice.

The Solid Power XL detergent is commercially available from Ecolab, Inc. Institutional Division, St. Paul, Minn. According to the Material Safety Data Sheets provided by Ecolab on its website, Solid Power XL detergent has sodium hydroxide as its primary ingredient.

The invention was examined in polymeric materials such as NAS 30, and PMMA.

In one embodiment, acceptable transmission limits for NAS 30, and PMMA after OSD testing are as presented in Table 2.

TABLE 2

| | 24 hrs Canola Oil and 24 hr Solid |
|---|---|
| | Power XL detergent Exposure |
| NAS 30 | >45% or >47% or >50% or |
| | >60% or >65%>or >70% >75% |
| PMMA | >45% or >47% or >50% |

Examples 1-8 demonstrate various testing with acrylic polymers.

### Example 1

0 wt % of any antioxidant was compounded with PMMA using an 18 mm twin screw extruder at 230° C. and 280-300 RPMs, resulting in a material with no additive but a similar molecular weight as it had seen the same processing steps. The extruded material was chopped into pellets and then directly molded into 10.16×10.16×0.318 cm plaques using a Toyo 110 ton injection molding machine at 232° C. OSD testing was performed with canola oil and Solid Power XL detergent.

### Example 2

0.05 wt % BHT and 0.05 wt % AO 1076 were compounded with PMMA using an 18 mm twin screw extruder at 230° C. and 280-300 RPMs. HPLC analysis shows actual loading levels of 0.04 wt % BHT and 0.05 wt % AO 1076. The extruded material was chopped into pellets and then directly molded into 10.16×10.16×0.318 cm plaques using a Toyo 110 ton injection molding machine at 232° C. OSD testing was performed with canola oil and Solid Power XL detergent.

### Example 3

0.25 wt % BHT and 0.25 wt % AO 1076 were compounded with PMMA using an 18 mm twin screw extruder at 230° C. and 280-300 RPMs. HPLC analysis shows actual loading levels of 0.20 wt % BHT and 0.21 wt % AO 1076. The extruded material was chopped into pellets and then directly molded into 10.16×10.16×0.318 cm plaques using a Toyo 110 ton injection molding machine at 232° C. OSD testing was performed with canola oil and Solid Power XL detergent.

### Example 4

0.50 wt % BHT and 0.50 wt % AO 1076 were compounded with PMMA using an 18 mm twin screw extruder at 230° C. and 280-300 RPMs. HPLC analysis shows actual loading levels of 0.38 wt % BHT and 0.41 wt % AO 1076. The extruded material was chopped into pellets and then directly molded into 10.16×10.16×0.318 cm plaques using a Toyo 110 ton injection molding machine at 232° C. OSD testing was performed with canola oil and Solid Power XL detergent.

### Example 5

0 wt % of any antioxidant was compounded with NAS 30 using an 18 mm twin screw extruder at 245° C. and 280-300 RPMs, resulting in a material with no additive but a similar molecular weight as it had seen the same processing steps. The extruded material was chopped into pellets and then directly molded into 10.16×10.16×0.318 cm plaques using a Toyo 110 ton injection molding machine at 227° C. OSD testing was performed with canola oil and Solid Power XL detergent.

### Example 6

0.05 wt % BHT and 0.05 wt % AO 1076 were compounded with NAS 30 using an 18 mm twin screw extruder at 245° C. and 280-300 RPMs. HPLC analysis shows actual loading levels of 0.04 wt % BHT and 0.04 wt % AO 1076. The extruded material was chopped into pellets and then directly molded into 10.16×10.16×0.318 cm plaques using a Toyo 110 ton injection molding machine at 227° C. OSD testing was performed with canola oil and Solid Power XL detergent.

### Example 7

0.25 wt % BHT and 0.25 wt % AO 1076 were compounded with NAS 30 using an 18 mm twin screw extruder at 245° C. and 280-300 RPMs. HPLC analysis shows actual loading levels of 0.18 wt % BHT and 0.20 wt % AO 1076. The extruded material was chopped into pellets and then directly molded into 10.16×10.16×0.318 cm plaques using a Toyo 110 ton injection molding machine at 227° C. OSD testing was performed with canola oil and Solid Power XL detergent.

### Example 8

0.5 wt % BHT and 0.5 wt % AO 1076 were compounded with NAS 30 using an 18 mm twin screw extruder at 245° C. and 280-300 RPMs. HPLC analysis shows actual loading levels of 0.37 wt % BHT and 0.42 wt % AO 1076. The extruded material was chopped into pellets and then directly molded into 10.16×10.16×0.318 cm plaques using a Toyo 110 ton injection molding machine at 227° C. OSD testing was performed with canola oil and Solid Power XL detergent.

TABLE 3
Percent transmission for Examples 1-8 after OSD testing.

| | Percent Transmission after 24 h |
|---|---|
| | in canola oil and 24 h in Solid |
| | Power XL detergent |
| Example 1 | 5 |
| Example 2 | 23 |
| Example 3 | 48 |
| Example 4 | 28 |
| Example 5 | 2 |
| Example 6 | 77 |
| Example 7 | 68 |
| Example 8 | 62 |

It can be clearly seen from a comparison of the data in the above relevant working examples that a combination of the phenolic antioxidants useful in the invention within a certain loading level can reduce oxidative degradation at the surface of the acrylic polymers.

The invention has been described in detail with reference to the embodiments disclosed herein, but it will be understood that variations and modifications can be effected within the scope of this invention.

I claim:

1. A polymer composition comprising:
(A) an acrylic polymer, and
(B) a stabilizing composition comprising:
(1) a phenolic antioxidant without a long-chain substituent; and
(2) a phenolic antioxidant with a long-chain substituent,
wherein the phenolic antioxidant (1) has 10 to 20 carbon atoms,
wherein the phenolic antioxidant (2) has greater than 20 carbon atoms, and
wherein the weight ratio of phenolic antioxidant (1) to phenolic antioxidant (2) is from 0.7:1 to 1.3:1.

2. The polymer composition according to claim 1, wherein at least one of the phenolic antioxidants is sterically hindered.

3. The polymer composition according to claim 1, wherein each of phenolic antioxidants (1) and (2) are sterically hindered.

4. The polymer composition according to claim 1, wherein the weight ratio of phenolic antioxidant (1) to phenolic antioxidant (2) is from 0.8:1 to 1.2:1.

5. The polymer composition according to claim 1, wherein the weight ratio of phenolic antioxidant (1) to phenolic antioxidant (2) is from 0.9:1 to 1.1:1.

6. The polymer composition according to claim 1, wherein the weight ratio of phenolic antioxidant (1) to phenolic antioxidant (2) is from 0.95:1 to 1.05:1.

7. The polymer composition according to claim 1, wherein the phenolic antioxidant (1) is butylated hydroxytoluene (BHT) or butylated hydroxyanisole (BHA).

8. The polymer composition according to claim 1, wherein the phenolic antioxidant (1) is butylated hydroxytoluene (BHT).

9. The polymer composition according to claim 1, wherein the phenolic antioxidant (2) is octadecyl-3-(3,5-di-tert-butyl-4-hydroxyphenyl)-propionate.

10. The polymer composition according to claim 1, wherein the phenolic antioxidant (2) is Vitamin E.

11. The polymer composition according to claim 1, wherein the phenolic antioxidant (1) is butylated hydroxytoluene (BHT) and the phenolic antioxidant (2) is octadecyl-3-(3,5-di-tert-butyl-4-hydroxyphenyl)-propionate.

12. A polymer composition comprising:
(a) an acrylic polymer;
(b) optionally a mold release agent; and
(c) a stabilizing effective amount of the stabilizing composition according to claim 1.

13. The polymer composition according to claim 12, wherein at least one acrylic polymer is selected from the group consisting of styrene-methyl methacrylate copolymers, poly(ethylmethacrylate), styrene-acrylonitrile polymers, and poly(methylmethacrylate).

14. The polymer composition according to claim 12, wherein at least one acrylic polymer is selected from the group consisting of styrene-methyl methacrylate and poly(methylmethacrylate).

15. The polymer composition according to claim 12, wherein at least one acrylic polymer is styrene-methyl methacrylate.

16. The polymer composition according to claim 12, wherein at least one acrylic polymer is poly(methylmethacrylate).

17. The polymer composition according to claim 12, wherein at least one acrylic polymers is styrene acrylonitrile.

18. The polymer composition according to claim 12, where the mold release agent is selected from the group consisting of erucylamide, stearamide, calcium stearate, stearic acid, montanic acid, montanic acid esters, montanic acid salts, oleic acid, palmitic acid, paraffin wax, polyethylene waxes, polypropylene waxes, carnauba wax, glycerol monostearate, and glycerol distearate.

19. The polymer composition according to claim 12 wherein the mold release agent is not zinc stearate.

20. The polymer composition according to claim 12, wherein the mold release agent is selected from stearic acid and palmitic acid.

21. The polymer composition according to claim 12, which comprises from 0.01 to 5 weight percent of the mold release agent.

22. The polymer composition according to claim 12, wherein the acrylic polymer is poly(methylmethacrylate) and wherein the stabilizing composition is present in the amount of: 0.30 to 0.50 weight percent, based on the total weight percentage of the polymer composition.

23. The polymer composition according to claim 12, wherein the acrylic polymer is styrene-methyl methacrylate and wherein the stabilizing composition is present in the amount of: 0.01 to 0.50 weight percent, based on the total weight percentage of the polymer composition.

24. A method for stabilizing an acrylic polymer against surface oxidative degradation, comprising:
incorporating into the acrylic polymer an effective stabilizing amount of the stabilizing composition according to claim 1.
